(19) United States
(12) Patent Application Publication
(10) Pub. No.: US 2017/0242621 A1
(43) Pub. Date: Aug. 24, 2017

(54) TRANSFERRING AN OBJECT FROM A FIRST PROCESS TO SECOND PROCESS

(71) Applicant: YANDEX EUROPE AG, Luzern (CH)

(72) Inventor: Grigory Victorovich DEMCHENKO, Moscow (RU)

(73) Assignee: YANDEX EUROPE AG, Luzem (CH)

(21) Appl. No.: 15/505,677

(22) PCT Filed: Dec. 23, 2014
(86) PCT No.: PCT/IB2014/067292

§ 371 Date: Feb. 22, 2017

(30) Foreign Application Priority Data
Sep. 30, 2014 (RU) 2014139553

(51) Int. Cl. G06F 3/06

(52) U.S. Cl. CPC G06F 3/0647; G06F 3/0613; G06F 3/0673

(57) ABSTRACT

Computer-implemented method for transferring an object from a first process to a second process, the first process having a first memory address space and the second process having a second memory address space, comprising allocating a contiguous block of memory at an address of the first memory address space; copying the object into the contiguous block of memory from one or more other blocks of memory in the first memory address space; and copying the contiguous block of memory from the address of the first memory address space to an address of the second memory address space, the address of the first memory address space and the address of the second memory address space being a same address, thereby rendering the object accessible to the second process at the address of the second memory address space. Also non-transitory computer-readable medium storing program instructions for carrying out the method.

### CROSS-REFERENCE

The present application claims convention priority to Russian Patent Application No. 2014139553, filed Sep. 30, 2014, entitled “METHOD FOR TRANSFERRING AN OBJECT FROM A FIRST PROCESS TO A SECOND PROCESS” which is incorporated by reference herein in its entirety.

### FIELD

The present technology relates to computer-implemented methods for transferring an object from a first process to a second process.

### BACKGROUND

There are many instances where it can be desirable to transfer an object from a first process to a second process, whether the second process is executed by a same computing device or a different computing device than the first process. For example, it may be desirable to process the object in discrete stages, such that a first process may begin processing the object in a first stage and the second process may continue processing the object in a second stage. In some cases, the object may be transferred from a first computer to a second more (or less) powerful computer so as to match the processing power of the computer to the processing task and/or to free computing resources of the first computer for other tasks. For example, it may be desirable to move processing of the object from one computer to another to balance a load across a cluster of computers.

Transferring an object from a first process to a second process involves copying the object from the memory address space of the first process to the memory address space of the second process. In order to do so, the object must first be serialized, by which is meant that the object must be represented in memory as a contiguous sequence of bytes. While simple object types (e.g. variables) such as integers and floating point numbers are typically stored in a contiguous block of memory and are therefore effectively serialized at all times, more complex object types such as linked lists, hash tables, and object-oriented objects, which are common in modern software, may span non-contiguous blocks of memory.

Conventionally, serialization of a complex object is performed by calling a serialization function specific to that type of object. For example, when programming a class of objects in an object-oriented programming language such as C++, a programmer may implement a serialization method suitable for serializing objects of that class.

### SUMMARY

The present technology provides a method whereby an object may be transferred between respective memory spaces of a first process and a second process without recourse to a serialization function specific to that type of object. Instead of type-specific serialization, a general approach for serializing objects of a variety of types is employed. The object is copied to a contiguous block of memory from one or more other blocks of memory in the memory address space of the first process. The contiguous block of memory then contains a serialized copy of the object, such that the contiguous block of memory may then be copied to the memory address space of the second process.

In order to maintain the integrity of any absolute references to memory addresses included in the object's data, the address at which the contiguous block of memory is stored in the memory address space of the second process must be the same as the address at which the contiguous block of memory was stored in the memory address space of the first process.

Thus, various implementations of the present technology provide a method for transferring an object from a first process to a second process, the first process having a first memory address space and the second process having a second memory address space, the method being executable by a processor of a computing device, the method comprising:
allocating a contiguous block of memory at an address of the first memory address space;
copying the object into the contiguous block of memory from one or more other blocks of memory in the first memory address space; and
copying the contiguous block of memory from the address of the first memory address space to an address of the second memory address space, the address of the first memory address space and the address of the second memory address space being a same address, thereby rendering the object accessible to the second process at the address of the second memory address space.

In some implementations, copying the object into the contiguous block of memory from the one or more other blocks of memory comprises:
substituting a custom memory allocator for a default memory allocator normally used by a copy function, the custom memory allocator being configured to allocate memory in the contiguous block of memory; and
executing the copy function in respect of the object, the copy function using the custom memory allocator to allocate memory for a copy of the object in the contiguous block of memory.

In some implementations, the copy function is a method of the object.

In some implementations, the one or more other blocks of memory were allocated using the default memory allocator.

In some implementations, the one or more other blocks of memory comprise at least two blocks of memory which are non-contiguous in the first memory address space.

In some implementations, the object is of a predetermined type expected by the second process. In other implementations, a type of the object is one of a plurality of types expected by the second process, and the method further comprises providing an indication of the type to the second process.

In some implementations, the same address is predetermined before execution of the first process and the second process. In other implementations, the method further comprises receiving the same address from the second process before allocating the contiguous block of memory. In yet other implementations, the method further comprises providing the same address to the second process.

In some implementations, the first process and the second process are instances of a same set of computer program instructions.

In some implementations, execution of the second process begins after execution of the first process is terminated. In other implementations, execution of the second process begins before execution of the first process is terminated.

In some implementations, the first process and the second process are executed by the processor of the computing device, and copying the contiguous block of memory from the address of the first memory address space to the address of the second memory address space comprises copying the contiguous block of memory to a persistent memory accessible by the second process. In some such implementations, the method further comprises accessing the contiguous block of memory by the second process at the address of the second memory address space.

In some implementations, the computing device is in communication with a second computing device via a network, the first process is executed by the processor of the computing device, the second process is executed by a processor of the second computing device, and copying the contiguous block of memory from the address of the first memory address space to the address of the second memory address space comprises sending the contiguous block of memory to the second computing device via the network.

In other aspect, various implementations of the present technology provide a method for receiving an object from a first process by a second process, the first process being executed by a processor of a first computing device and the second process being executed by a processor of a second computing device, the first computing device being in communication with the second computing device via a network, the first process having a first memory address space and the second process having a second memory address space, the method being executable by the processor of the second computing device, the method comprising:
receiving a contiguous block of memory from the first computing device, the contiguous block of memory including the object, the object having been copied by the processor of the first computing device into the contiguous block of memory from one or more other blocks of memory in the first memory address space, the contiguous block of memory having been allocated at an address of the first memory address space by the processor of the first computing device;
storing the contiguous block of memory at an address of the second memory address space, the address of the first memory address space and the address of the second memory address space being a same address; and
the second process accessing the object at the address of the second memory address space.

As above, in some implementations, the object is of a predetermined type expected by the second process. In some implementations, a type of the object is one of a plurality of types expected by the second process, and the method further comprises receiving an indication of the type by the second process. In some implementations, the same address is predetermined before execution of the first process and the second process. In some implementations, the method further comprises receiving the same address before storing the contiguous block of memory. In some implementations, the method further comprises providing the same address to the first process. In some implementations, the first process and the second process are instances of a same set of computer program instructions.

In other aspects, various implementations of the present technology provide a non-transitory computer-readable medium storing program instructions executable by one or more processors of one or more computing devices to carry out one or more of the above-recited methods. Thus, various implementations provide a non-transitory computer-readable medium storing program instructions for transferring an object from a first process to a second process, the first process having a first memory address space and the second process having a second memory address space, the program instructions being executable by a processor of a computing device to effect:
allocation of a contiguous block of memory at an address of the first memory address space;
copying of the object into the contiguous block of memory from one or more other blocks of memory in the first memory address space; and
copying of the contiguous block of memory from the address of the first memory address space to an address of the second memory address space, the address of the first memory address space and the address of the second memory address space being a same address, thereby rendering the object accessible to the second process at the address of the second memory address space.

Various implementations of the present technology provide A non-transitory computer-readable medium storing program instructions for receiving an object from a first process by a second process, the first process being executed by a processor of a first computing device and the second process being executed by a processor of a second computing device, the first computing device being in communication with the second computing device via a network, the first process having a first memory address space and the second process having a second memory address space, the program instructions being executable by a processor of the second computing device to effect:
reception of a contiguous block of memory from the first computing device, the contiguous block of memory including the object, the object having been copied by the processor of the first computing device into the contiguous block of memory from one or more other blocks of memory in the first memory address space, the contiguous block of memory having been allocated at an address of the first memory address space by the processor of the first computing device;
storage of the contiguous block of memory at an address of the second memory address space, the address of the first memory address space and the address of the second memory address space being a same address; and
accessing by the second process of the object at the address of the second memory address space.

In the context of the present specification, unless expressly provided otherwise, a “computing device” is any hardware and/or software appropriate to the relevant task at hand.

Thus, some non-limiting examples of electronic devices include computer processors, computer systems (one or more servers, desktops, laptops, netbooks, etc.), smartphones, and tablets, as well as network equipment such as routers, switches, and gateways.

In the context of the present specification, unless expressly provided otherwise, a first device should be understood to be “in communication with” a second device if each of the devices is capable of sending information to and receiving information from the other device, across any physical medium or combinations of physical media, at any distance, and at any speed. As a non-limiting example, two digital electronic device(s) may communicate over a network such as the Internet. As another non-limiting example, the first device and the second device may be virtual devices executing on the same digital electronic hardware, in which case communication may occur by any means available on such digital electronic hardware, such as inter-process communication.

In the context of the present specification, unless expressly provided otherwise, the expression “computer-readable medium” is intended to include media of any nature and kind whatsoever, non-limiting examples of which include RAM, ROM, disks (CD-ROMs, DVDs, floppy disks, hard disk drives, etc.), USB keys, flash memory cards, solid state-drives, and tape drives.

In the context of the present specification, unless expressly provided otherwise, an “object” refers to a discrete parcel of information. As such, objects may refer to instances of classes according to an object-oriented programming language such as C++, but also to variables in other programming languages, or any other discrete parcel of information. Moreover, in the context of the present specification, an “object” may refer not only to a single object, but also to a collection of objects, for example an array or a vector comprising a plurality of objects.

In the context of the present specification, unless expressly provided otherwise, an “indication” of an information element may be the information element itself or a pointer, reference, link, or other indirect mechanism enabling the recipient of the indication to locate a network, memory, database, or other computer-readable medium location from which the information element may be retrieved. For example, an indication of a file could include the file itself (i.e. its contents), or it could be a unique file descriptor identifying the file with respect to a particular filesystem, or some other means of directing the recipient of the indication to a network location, memory address, database table, or other location where the file may be accessed. As one skilled in the art would recognize, the degree of precision required in such an indication depends on the extent of any prior understanding about the interpretation to be given to information being exchanged as between the sender and the recipient of the indication. For example, if it is understood prior to a communication between a sender and a recipient that an indication of an information element will take the form of a database key for an entry in a particular table of a predetermined database containing the information element, then the sending of the database key is all that is required to effectively convey the information element to the recipient, even though the information element itself was not transmitted as between the sender and the recipient of the indication.

[28] In the context of the present specification, unless expressly provided otherwise, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, event type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a diagram of a networked computing environment suitable for use with non-limiting implementations of the present technology;

FIG. 2 is a block diagram representing copy operations in relation to blocks of memory in a first memory address space and a second memory address space according to an non-limiting implementation of the present technology; and

FIGS. 3 and 4 are flowcharts illustrating steps performed in non-limiting method implementations of the present technology.

It should also be noted that, unless otherwise explicitly specified, the drawings are not to scale.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

With these fundamentals in place, we will now consider some examples to illustrate various implementations of aspects of the present technology.

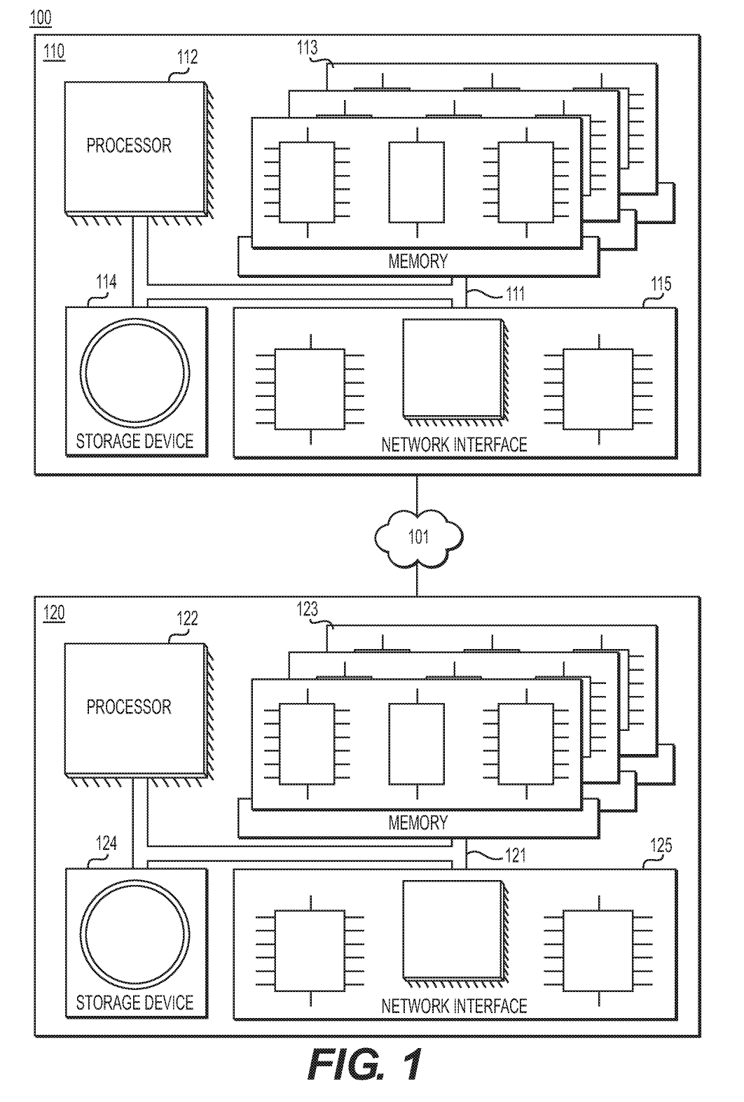

In FIG. 1, there is shown a networked computing environment 100 suitable for use with some implementations of the present technology. The networked computing environment 100 includes a computer 110 in communication with a computer 120 via a network 101 (e.g. the Internet). Each of computer 110 and computer 120 comprises various hardware modules in communication with one another via one or more buses 111 (and 121), including one or more single or multi-core processors 112 (and 122), a random access memory 113 (and 123), a storage device 114 (and 124), and one or more network interfaces 115 (and 125) coupled to the network 101.

While each of computer 110 and computer 120 is depicted as a single physical computer (which by implication comprises hardware modules including one or more processors, memory, and a network interface), it will be understood that one or both of computer 110 and computer 120 may be implemented as a plurality of networked computers or as one or more virtual machines running on one or more physical computers.

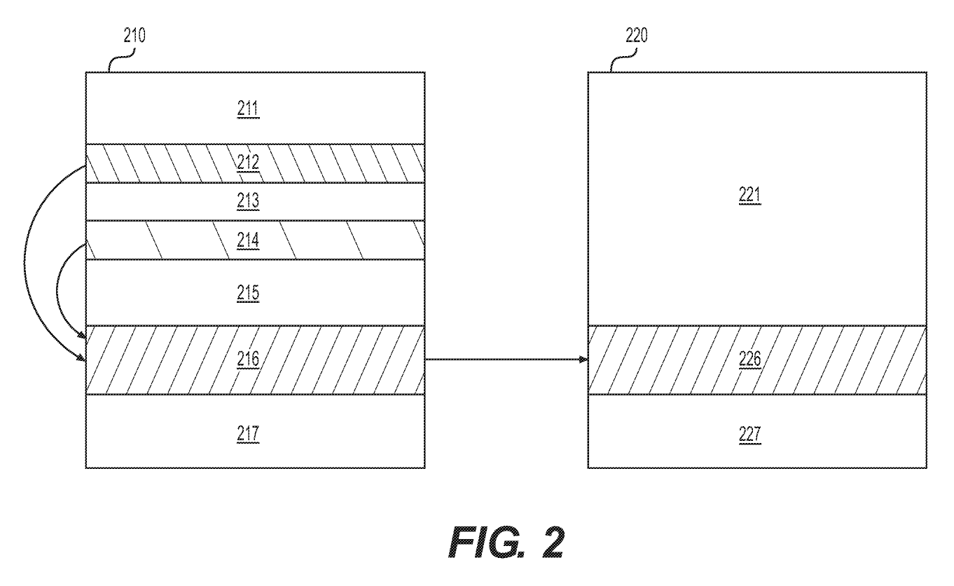

FIG. 2 is a block diagram representing copy operations in relation to a first memory address space 210 of a first process and a second memory address space 220 of a second process. The first process and the second process may be instances of a same set of program instructions, or they may be instances of different sets of program instructions. In the context of the networked computing environment 100, the first process may be executed by the processor 112 of the computer 110, and the first memory address space 210 may be a virtual memory address space which corresponds to addresses of the physical memory 113 of the computer 110.

In some implementations, the second process may also be executed by the processor 112 of the computer 110, and the second memory address space 220 may be a virtual memory address space which also corresponds to addresses of the physical memory 113 of the computer 110. In other implementations, the second process may be executed by the processor 122 of the computer 120, and the second memory address space 220 may be a virtual memory address space which corresponds to the physical memory 123 of the computer 120.

The first memory address space 210 includes seven blocks of memory respectively labelled 211 to 217. Each of the blocks of memory 211 to 217 has an address in the first memory address space 210. As depicted in FIG. 2, blocks of memory nearer to the top of the first memory address space 210 have lower addresses than blocks of memory nearer to the bottom of the first memory address space 210. For example, block of memory 211 has a lower memory address than block of memory 212, block of memory 212 has a lower memory address than block of memory 213, and so on.

In FIG. 2, blocks of memory 212, 214, 216, and 226 are shaded to indicate that they contain data of an object being transferred from a first process to a second process according to an implementation of the present technology. The remaining blocks of memory 211, 213, 215, 217, 221, and 227 may contain other objects, program code, etc., or they may be unallocated (free).

Blocks of memory 212 and 214 are non-contiguous in the first memory address space 210 because there is a hole (the intervening block of memory 213) at an address higher than that of block of memory 212 but lower than that of block of memory 214. Block of memory 216 is a contiguous block of memory because it has no holes.

There are various scenarios in which an object may be stored in non-contiguous blocks of memory such as blocks of memory 212 and 214. As just one example, the object may be an instance of a class having been programmed in an object-oriented programming language such as C++, such as a class for representing a building as part of a computer-aided design (CAD) software application. A “Building” object (i.e. an instance of a “Building” class) may comprise a number of member variables, such as floating-point variables (“latitude”, “longitude”, “height”, “width”, “depth”) for representing a geographical location and dimensions of the building. The Building object may also comprise references to objects representing various components of the building. For example, a Building object may include a “doors” reference to an array of “Door” objects, a “walls” reference to an array of “Wall” objects, and so on, to represent the various objects that make up the building represented by the Building object.

At run-time, the CAD application may instantiate a new Building object by using a memory allocator (e.g. the “malloc” function in C, the “new” function in C++, or equivalent functions in other programming languages). The memory allocator allocates sufficient memory to store a Building object. Because every Building object is defined to have a geographical position and dimensions, the memory allocator will therefore allocate memory (e.g. in block of memory) large enough to store at least the five floating-point member variables “latitude”, “longitude”, “height”, “width”, and “depth”. The memory allocated will also be large enough to store the “doors” and “walls” references. However, unlike the floating-point member variables, these references do not contain the actual data of the Door and Wall objects to which they refer. Instead, they contain the memory addresses where those objects are stored. In other words, they merely point to the data, they do not contain it.

The Door and Wall objects would themselves be instantiated at run-time by again using the memory allocator to allocate memory for those objects. Depending on the operation of the memory allocator and the availability of memory within various blocks of memory of the first memory address space 210, the memory allocated for the Door and Wall objects may be allocated in the same block of memory (e.g. 212) as the floating-point member variables or a different block of memory (e.g. 214) than the floating-point member variables. For example, if there is insufficient free memory remaining in the block of memory 212 to store the Door and/or Wall objects, the memory allocator may find a larger segment of free memory in another block of memory (e.g. 214) to accommodate them.

Thus, with reference to FIG. 2, a Building object may comprise member variables (e.g. floating-point member variables) and references to one or more objects stored in a first block of memory 212 allocated by the memory allocator, at least one of the references included in the first block of memory 212 pointing to one or more objects in a second block of memory 214. The object may thus be said to span the blocks of memory 212 and 214, which are non-contiguous in the first memory address space 210.

In order to render the object susceptible for being transferred to the second memory address space 220, the object must first be serialized, i.e. represented as a contiguous sequence of bytes. According to implementations of the present technology, this is achieved by allocating a contiguous block of memory 216 sufficiently large to contain all of the data of the object, and then copying that data to the contiguous block of memory 216. These one or more copy operations are represented by the two arrows from blocks of memory 212 and 214 to the contiguous block of memory 216.

As part of copying the object, the object's references to its constituent Door and Wall objects are updated to refer to the memory addresses within the contiguous block of memory 216 where the Door and Wall objects are stored.

Having been serialized, the object may then be transferred to the second process by copying the contiguous block of memory 216 to a contiguous block of memory 226 in the second memory address space 220, the contiguous block of memory 226 being at least as large as the contiguous block of memory 216. In doing so, care must be taken to ensure that the address in the second memory address space 220 (i.e. the address of the contiguous block of memory 226) is the same as the address in the first memory address space 210 where the contiguous block of memory 216 was stored. This preserves the integrity of any absolute references to memory addresses included in the object (e.g. the Building object's references to its constituent Door and Wall objects).

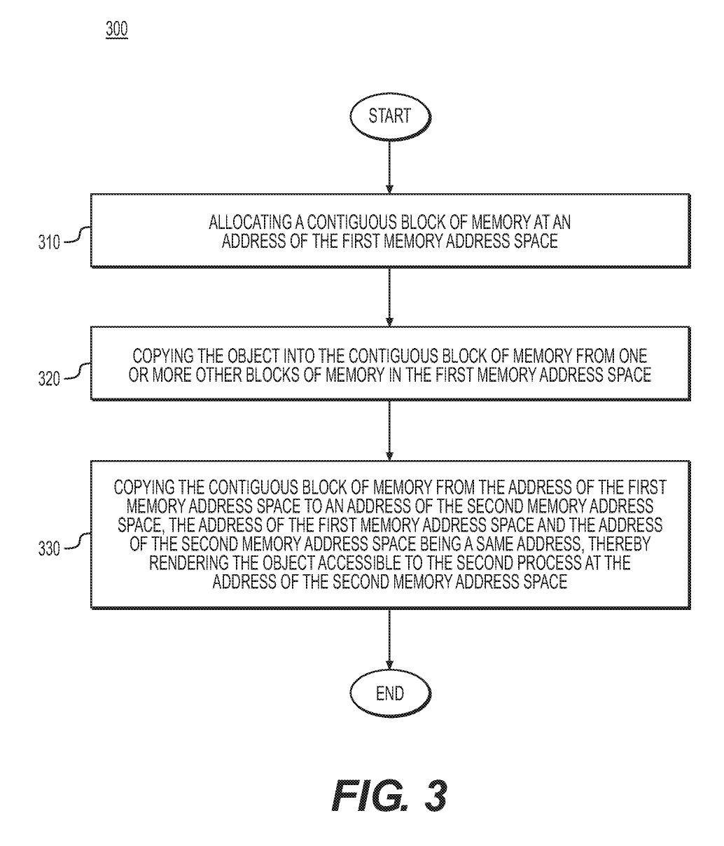

Turning to FIG. 3, there is illustrated a first method implementation 300 of the present technology. The method 300 may be carried out, for example, by the processor 112 of computer 110 in the context of the networked computing environment 100 of FIG. 1. The method 300 is for transferring an object from a first process to a second process, the first process having a first memory address space and the second process having a second memory address space, the method being executable by a processor of a computing device. The method 300 comprises steps 310 to 330.

At step 310, a contiguous block of memory 216 is allocated at an address of the first memory address space 210.

At step 320, the object is copied into the contiguous block of memory 216 from one or more other blocks of memory 212, 214 in the first memory address space 210. In some implementations, step 320 may comprise substituting a custom memory allocator for a default memory allocator normally used by a copy function (e.g. a copy method of the object), the custom memory allocator being configured to allocate memory in the contiguous block of memory 216, then executing the copy function in respect of the object, the copy function using the custom memory allocator to allocate memory for a copy of the object in the contiguous block of memory 216. For programs written in C or C++, substitution of the memory allocator can be achieved by overloading the malloc, calloc and new functions so that as new variables are declared and allocated at program execution time, they are written to the contiguous region of memory 216 rather than being distributed across non-contiguous memory locations (e.g. 212, 214).

Equivalent techniques can be employed for programs written in other languages; or indeed other techniques for achieving the same result can be employed according to the operating system environment of the program. In other words, the custom memory allocator ensures that any memory used by the copy function to store the copy of the object is within the contiguous block of memory 216. Moreover, any constituent objects of the object (e.g. Door and Wall objects of a Building object) are also copied using the custom memory allocator, thus ensuring that memory for copies of those objects will also be allocated within the contiguous block of memory 216. Therefore, after the copy operation, the contiguous block of memory 216 completely contains (the copy of) the object, including any constituent objects, and the references to those constituent objects refer to addresses within the contiguous block of memory 216 where the constituent objects are stored.

At step 330, the contiguous block of memory 216 is copied from the address of the first memory address space 210 to an address of the second memory address space 220, the address of the first memory address space 210 and the address of the second memory address space 220 being a same address. The result is that a contiguous block of memory 226 containing a copy of the object is stored in the second memory address space 220 at the same address that the contiguous block of memory 216 is stored in the first memory address space 210.

In some implementations, the address is predetermined before execution of the first process and the second process. For example, the address of the contiguous block of memory 216, 226 may be determined in the source code of the first process and the source code of the second process. In other implementations, the address is not predetermined, and the method 300 further comprises providing the address to the second process, such that the second process knows where the contiguous block of memory 226 is stored in the second memory address space 220, and therefore where the object may be accessed. In yet other implementations, the second process may determine the address, in which case the method 300 further comprises, before allocating the contiguous block of memory 216, receiving the address from the second process.

In implementations wherein the first process and the second process are both executed on a same computing device (e.g. computer 110), step 330 may comprise copying the contiguous block of memory 216 to a persistent memory (e.g. in storage device 114) accessible by the second process. The method 300 may then further comprise a step of accessing the contiguous block of memory 226 by the second process at the address of the second memory address space 220.

In implementations wherein the first process is executed on a first computing device (e.g. computer 110) and the second process is executed on a second computing device (e.g. computer 120), the method 300 may further comprise a step of sending the contiguous block of memory 216 to the second computing device 120 via a network 101 to which both the first computing device and the second computing device are coupled.

In order for the second process to correctly interpret the copied object stored in the contiguous block of memory 226 stored in its memory address space 220, the second process must know what type of object it is (e.g. 32-bit integer, 64-bit floating-point number, string of one hundred and forty 8-bit characters, Building object, etc.). In some implementations, the second process is configured to expect the object to be of a particular predetermined type, in which case it does not need to be informed of the type of the object, and it may interpret the object in the contiguous block of memory 226 according to the definition of that predetermined type.

In other implementations, the second process may be configured to expect the object to be of one of a plurality of types, and the method 300 may then comprise a further step of providing an indication of the type to the second process. For example, the second process may be a CAD application which expects to receive either Building objects or Landscape objects from the first process. If the object being transferred is a Building object, an indication to that effect may be provided to the second process, so that it interprets the object stored in the contiguous block of memory 226 as a Building object and not as a Landscape object. The form this indication takes may vary by implementation, but in a simple example, each type may be assigned an integer value (e.g. Building=1, Landscape=2), and the integer value may be provided to the second process.

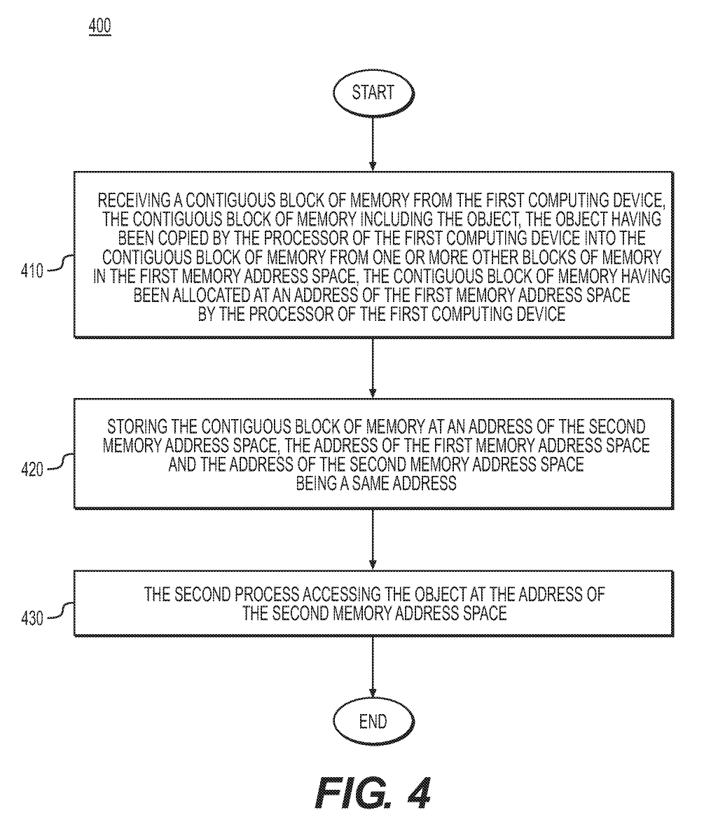

Turning to FIG. 4, there is illustrated a second method implementation 400 of the present technology. The method 400 may be carried out, for example, by the processor 122 of computer 120 in the context of the networked computing environment 100 of FIG. 1. The method 400 is for receiving an object from a first process by a second process, the first process being executed by a processor 112 of a first computing device 110 and the second process being executed by a processor 122 of a second computing device 120, the first computing device 110 being in communication with the second computing device 120 via a network 101, the first process having a first memory address space 210 and the second process having a second memory address space 220, the method being executable by the processor 122 of the second computing device 120. The method 400 comprises steps 410 and 430.

At step 410, a contiguous block of memory is received from the first computing device, the contiguous block of memory including the object, the object having been copied by the processor of the first computing device into the contiguous block of memory from one or more other blocks of memory in the first memory address space, the contiguous block of memory having been allocated at an address of the first memory address space by the processor of the first computing device

At step 420, the contiguous block of memory is stored at an address of the second memory address space, the address of the first memory address space and the address of the second memory address space being a same address. In some implementations, the address is predetermined before execution of the first process and the second process. For example, the address of the contiguous block of memory 216, 226 may be determined in the source code of the first process and the source code of the second process. In other implementations, the address is not predetermined, and the method 400 further comprises receiving the address, such that the second process knows where the contiguous block of memory 226 is to be stored in the second memory address space 220. In yet other implementations, the second process may determine the address, in which case the method 400 further comprises providing the address to the first process.

At step 430, the second process accesses the object at the address of the second memory address space. In some implementations, the second process is configured to expect the object to be of a particular predetermined type, in which case it does not need to be informed of the type of the object, and it may interpret the object in the contiguous block of memory 226 according to the definition of that predetermined type. In other implementations, the second process may be configured to expect the object to be of one of a plurality of types, and the method 400 may then comprise a further step of providing an indication of the type to the second process.

It will be appreciated that while the above method has been described for non-limiting purposes with a specific sequence of steps, the various steps can be rearranged where possible to achieve the same effect.

Modifications and improvements to the above-described implementations of the present technology may become apparent to those skilled in the art. The foregoing description is intended to be non-limiting rather than limiting. The scope of the present technology is therefore intended to be limited solely by the scope of the appended claims.

1. A method for transferring an object from a first process to a second process, the first process having a first memory address space and the second process having a second memory address space, an entirety of the object comprising at least one constituent object and at least one reference to said at least one constituent object stored in non-contiguous blocks of memory at a plurality of addresses of the first memory address space, the method being executable by a processor of a computing device, the method comprising:
allocating a contiguous block of memory at an address of the first memory address space;
copying the entirety of the object into the contiguous block of memory from the non-contiguous blocks of memory in the contiguous block of memory of the first memory address space; and
copying the contiguous block of memory from the address of the first memory address space to an address of the second memory address space, the address of the first memory address space and the address of the second memory address space being a same address, thereby rendering the object accessible to the second process at the address of the second memory address space.

2. The method of claim 1, wherein copying the object into the contiguous block of memory from the one or more other blocks of memory comprises:
substituting a custom memory allocator for a default memory allocator normally used by a copy function, the custom memory allocator being configured to allocate memory in the contiguous block of memory; and
executing the copy function, the copy function being a method of the object, in respect of the object, the copy function using the custom memory allocator to allocate memory for a copy of the object in the contiguous block of memory.

3-5. (canceled)

6. The method of claim 1, wherein the object is of a predetermined type expected by the second process.

7. The method of claim 1, wherein a type of the object is one of a plurality of types expected by the second process, and the method further comprises providing an indication of the type to the second process.

8. The method of claim 1, wherein the same address is predetermined before execution of the first process and the second process.

9. The method of claim 1, further comprising receiving the same address from the second process before allocating the contiguous block of memory.

10. The method of claim 1, further comprising providing the same address to the second process.

11. The method of claim 1, wherein the first process and the second process are instances of a same set of computer program instructions.

12. The method of claim 1, wherein execution of the second process begins after execution of the first process is terminated.

13. The method of claim 1, wherein execution of the second process begins before execution of the first process is terminated.

14. The method of claim 1, wherein the first process and the second process are executed by the processor of the computing device, and copying the contiguous block of memory from the address of the first memory address space to the address of the second memory address space comprises copying the contiguous block of memory to a persistent memory accessible by the second process.

15. The method of claim 14, further comprising accessing the contiguous block of memory by the second process at the address of the second memory address space.

16. The method of claim 1, wherein the computing device is in communication with a second computing device via a network, the first process is executed by the processor of the computing device, the second process is executed by a processor of the second computing device, and copying the contiguous block of memory from the address of the first memory address space to the address of the second memory address space comprises sending the contiguous block of memory to the second computing device via the network.

17. A method for receiving an object from a first process by a second process, an entirety of the object comprising at least one constituent object and at least one reference to said at least one constituent object being stored in non-contiguous blocks of memory at a plurality of addresses of the first memory address space, the first process being executed by a processor of a first computing device and the second process being executed by a processor of a second computing device, the first computing device being in communication with the second computing device via a network, the first process having a first memory address space and the second process having a second memory address space, the method being executable by the processor of the second computing device, the method comprising:
receiving a contiguous block of memory from the first computing device, the contiguous block of memory including the entirety of the object, the object having been copied by the processor of the first computing device into the contiguous block of memory from the non-contiguous blocks of memory in the first memory address space, the contiguous block of memory having been allocated at an address of the first memory address space by the processor of the first computing device;
storing the contiguous block of memory at an address of the second memory address space, the address of the first memory address space and the address of the second memory address space being a same address; and
the second process accessing the object at the address of the second memory address space.

18. The method of claim 17, wherein the object is of a predetermined type expected by the second process.

19. The method of claim 18, wherein a type of the object is one of a plurality of types expected by the second process, and the method further comprises receiving an indication of the type by the second process.

20. The method of claim 17, wherein the same address is predetermined before execution of the first process and the second process.

21. (canceled)

22. The method of claim 17, further comprising providing the same address to the first process.

23. The method of claim 17, wherein the first process and the second process are instances of a same set of computer program instructions.

24. A system for transferring an object from a first process to a second process, the first process having a first memory address space and the second process having a second memory address space, an entirety of the object comprising at least one constituent object and at least one reference to said at least one constituent object stored in non-contiguous blocks of memory at a plurality of addresses of the first memory address space, the system comprising:
a processor of a computing device to effect:
allocation of a contiguous block of memory at an address of the first memory address space;
copying of the entirety of the object into the contiguous block of memory from the non-contiguous blocks of memory in the contiguous block of memory of the first memory address space; and
copying of the contiguous block of memory from the address of the first memory address space to an address of the second memory address space, the address of the first memory address space and the address of the second memory address space being a same address, thereby rendering the object accessible to the second process at the address of the second memory address space.

25-46. (canceled)
